(19) United States
(12) Patent Application Publication
(10) Pub. No.: US 2004/0220030 A1
(43) Pub. Date: Nov. 4, 2004

(54) Exerciser having a stable base

(76) Inventor: Julian Chu, San Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/458,682

(22) Filed: Jun. 11, 2003

(30) Foreign Application Priority Data
Apr. 29, 2003 (TW) 092206778

(51) Int. Cl. A63B 22/00; A63B 71/00; G06K 9/00; A63B 26/00

(52) U.S. Cl. 482/142; 482/51

(57) ABSTRACT

An exerciser includes a base including a top and a semispherical member including a semispherical periphery having a lower end. The lower end of the semispherical periphery of the semispherical member includes an engaging portion for engaging with the top of the base. The semispherical member further includes a bottom side that does not extend beyond a plane on which the lower end of the semispherical periphery of the semispherical member lies.

### BACKGROUND OF THE INVENTION

1. Field of the Invention

The present invention relates to an exerciser having a stable base.

2. Description of the Related Art

FIG. 1 of the drawings illustrates a ball 1 that is sometimes recommended by a doctor for rehabilitation purposes. The ball 1 is filled with filling material or inflated with air or water. However, the user cannot stand on the ball 1 that rolls easily. FIG. 2 illustrates a semispherical member 1A to provide a more stable support. However, it was found that the semispherical member 1A is apt to slide. The present invention is intended to provide an exerciser that may serve as a rehabilitating device while avoiding the above drawbacks.

### SUMMARY OF THE INVENTION

An exerciser in accordance with the present invention includes a base including a top and a semispherical member including a semispherical periphery having a lower end. The lower end of the semispherical periphery of the semispherical member includes an engaging portion for engaging with the top of the base. The semispherical member further includes a bottom side that does not extend beyond a plane on which the lower end of the semispherical periphery of the semispherical member lies.

The semispherical periphery of the semispherical member includes a plurality of protrusions for providing a massaging function for rehabilitation purposes.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a conventional ball for rehabilitation.

FIG. 2 is a perspective view illustrating a conventional semispherical member for rehabilitation.

FIG. 3 is an exploded perspective view of a first embodiment of an exerciser in accordance with the present invention.

FIG. 4 is an exploded perspective view of a second embodiment of the exerciser in accordance with the present invention.

FIG. 5 is a sectional view of a semispherical member of the exerciser in FIG. 3.

FIG. 6 is an upside-down perspective view, partly exploded, of a modified embodiment of a base of the exerciser in accordance with the present invention.

FIG. 7 is a perspective view of a modified embodiment of the semispherical member of the exerciser in accordance with the present invention.

FIG. 8 is a perspective view of another embodiment of the exerciser in accordance with the present invention.

FIG. 9 is a schematic perspective view illustrating a modified embodiment for engaging the base and the semispherical member of the exerciser in accordance with the present invention.

FIG. 10 is an exploded perspective view illustrating a further modified embodiment of the exerciser in accordance with the present invention.

FIG. 11 is a schematic perspective view illustrating use of the exerciser in accordance with the present invention.

FIG. 12 is a schematic perspective view illustrating another use of the exerciser in accordance with the present invention.

FIG. 13 is a schematic perspective view illustrating a further use of the exerciser in accordance with the present invention.

FIG. 14 is a schematic perspective view illustrating still another use of the exerciser in accordance with the present invention.

FIG. 15 is a schematic side view of still another modified embodiment of the exerciser in accordance with the present invention.

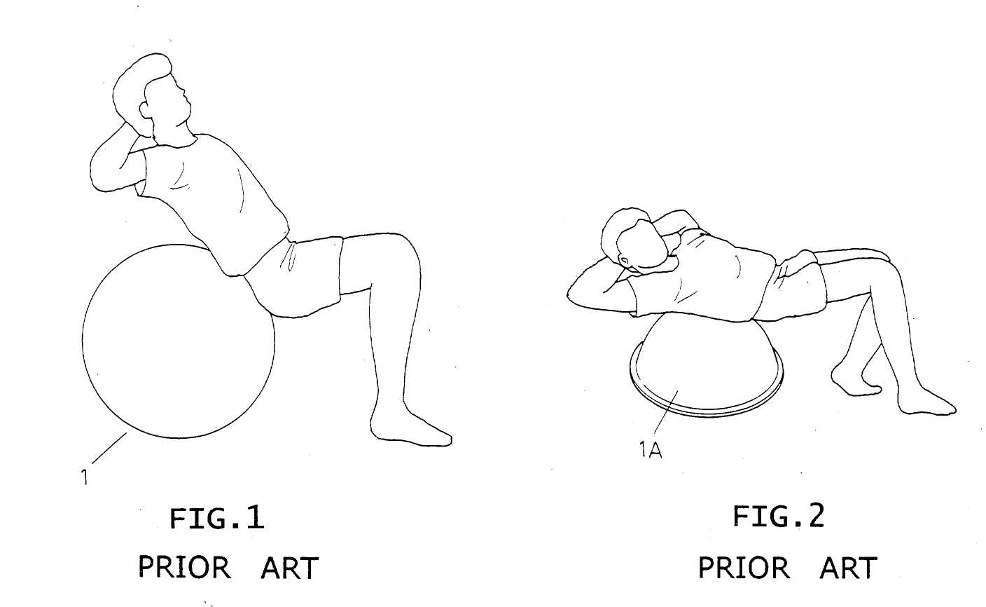

### DETAILED DESCRIPTION OF THE PREFERRED EMBODIMENTS

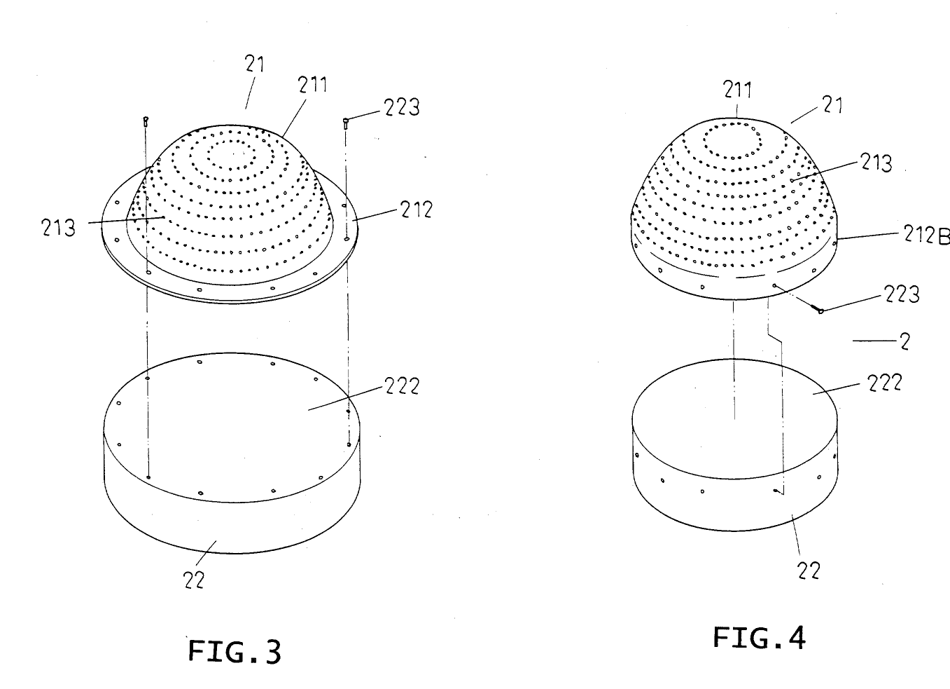

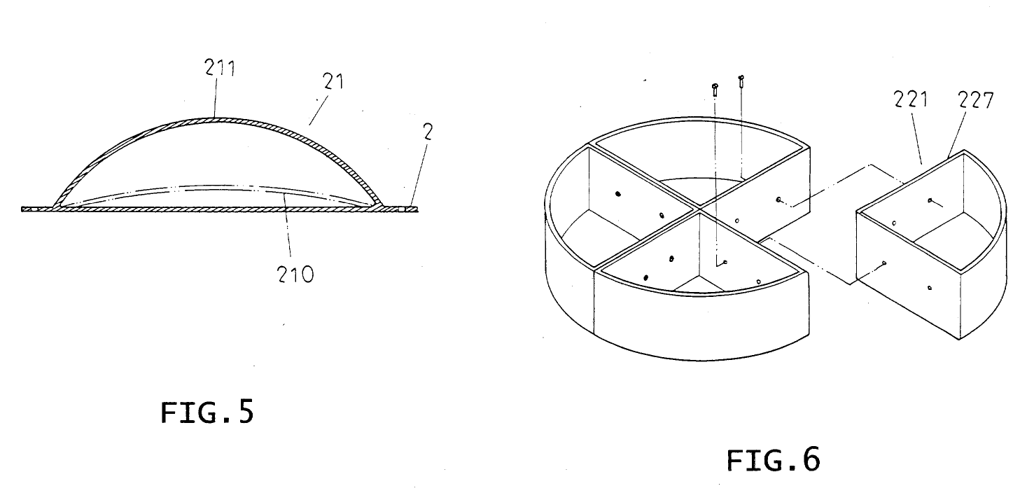

Referring to FIG. 3, an exerciser in accordance with the present invention generally comprises a base 22 and a semispherical member 21 securely mounted on top of the base 22. The base 22 includes a planar top face 222. The semispherical member 21 includes a semispherical periphery 211 having a plurality of protrusions 213 formed thereon. An engaging portion in the form of an annular flange 212 is formed on a lower end of the semispherical periphery 211 and extends along a plane perpendicular to a longitudinal axis of the exerciser. A plurality of fasteners such as screws 223 are extended through fixing holes (not labeled) defined in the annular flange 212 and screw holes (not labeled) defined in the planar top face 222 of the base 22. The semispherical member 21 further includes a bottom side that does not protrude downward beyond a plane on which the lower end of the semispherical periphery 211 lies. Preferably, as illustrated in FIG. 5, the bottom side 210 of the semispherical member 21 is arcuate and spaced apart from the planar top face 222 of the base 22 when the semispherical member 21 is securely mounted to the base 22. Thus, a suction cup effect may be obtained, thereby improving the engaging effect between the base 22 and the semispherical member 21.

FIG. 4 illustrates a modified embodiment of the exerciser, wherein the engaging portion of the semispherical member 21 is a skirt or an annular wall 212B that extends in a direction parallel to the longitudinal direction of the exerciser. Of course, the position of the fixing holes of the annular wall 212B and the position of the screw holes of the base 22 are changed.

FIG. 6 illustrates a modified embodiment of the base. In this embodiment, the base includes a plurality of base units 221 that are assembled or engaged together to form a base, providing a base with a plurality of reinforcing plates that are formed by the rectilinear sides 227 of the base units 221. The base units 221 can be dismantled for convenient transport.

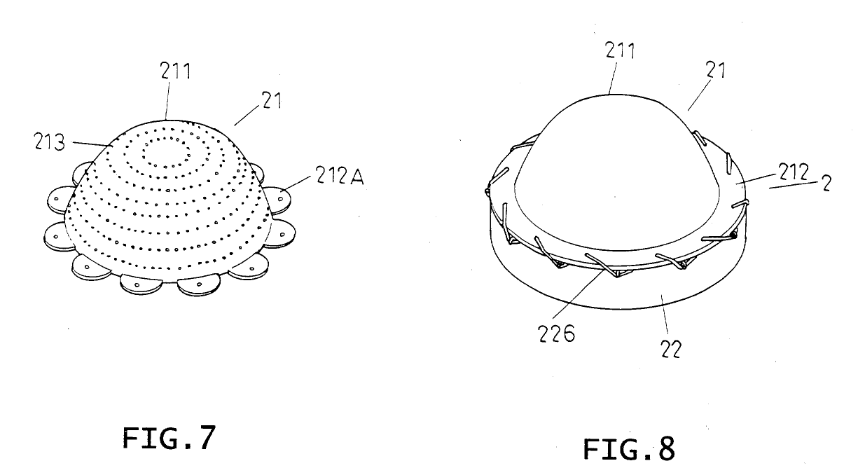

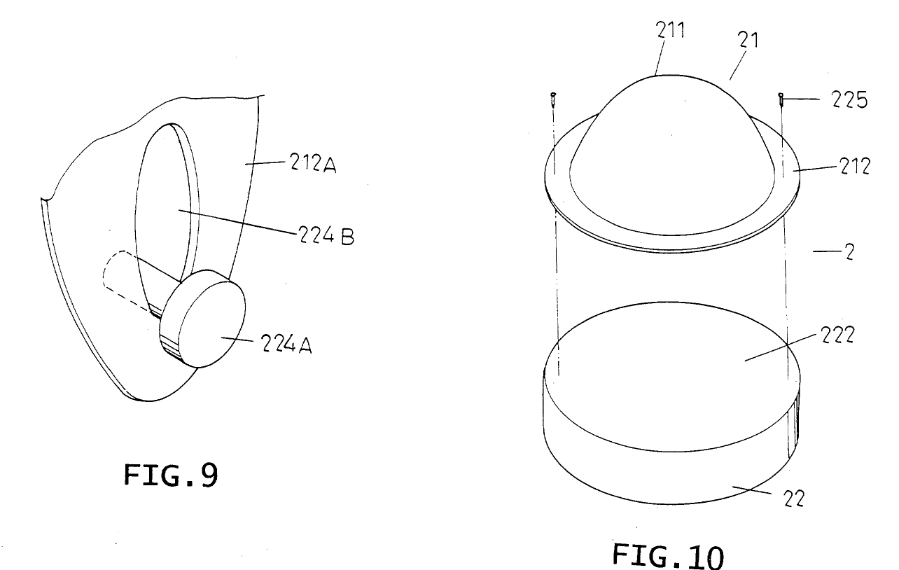

FIG. 7 illustrates another modified embodiment of the engaging portion. In this embodiment, the engaging portion includes a plurality of annularly spaced apart lugs 212A projecting radially outward from the lower end of the semispherical periphery 211. FIG. 9 illustrates a modified embodiment for securing the semispherical member 21 to the base 22, wherein each lug 212A includes a female engaging member such as an engaging hole 224B, and a respective male engaging member such as an engaging member 224A on the base 22 is engaged with the respective engaging hole 224B.

FIG. 8 illustrates a modified embodiment for securing the semispherical member 21 to the base 22 by means of straps 226.

FIG. 10 illustrates a modified embodiment for securing the semispherical member 21 to the base 22 by nails 225.

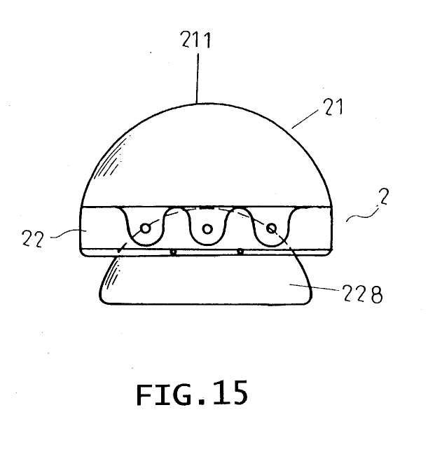

FIG. 15 illustrates a further modified embodiment of the invention, wherein the base 22 includes an inverted bowl member 228 extending downward from an inner side of the top of the base 22, providing an aesthetically pleasing effect.

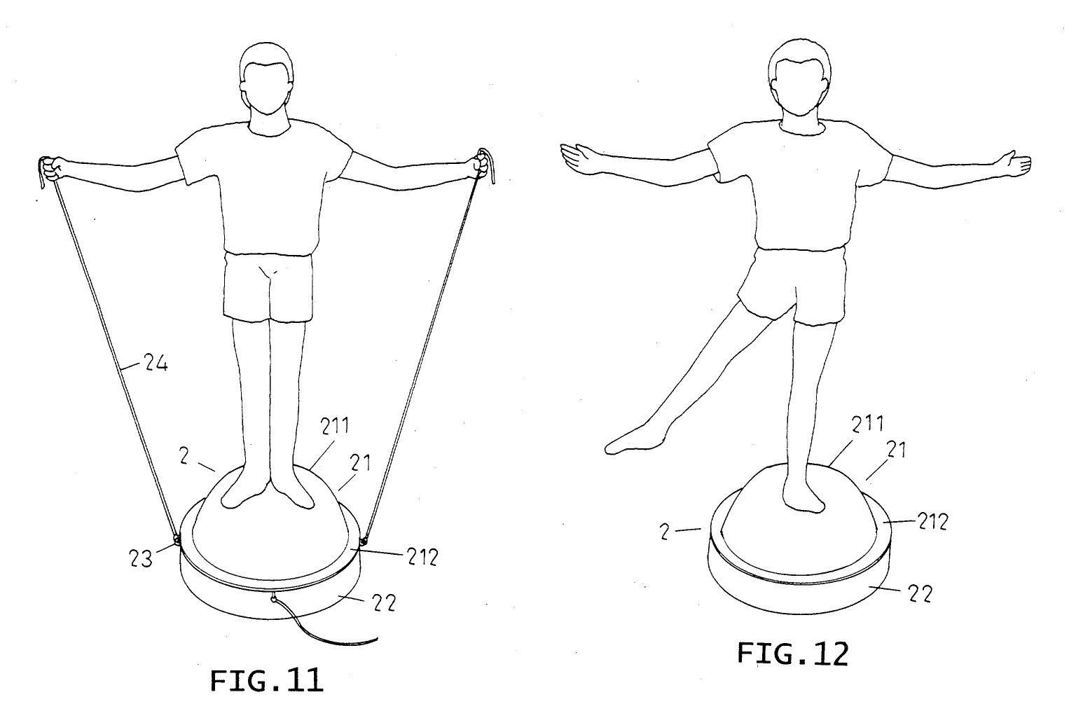

FIG. 11 illustrates use of the exerciser in accordance with the present invention, wherein a plurality of resilient pull strings 24 are attached to respective hooks 23 formed on the exerciser for exercising the arm muscles.

FIG. 12 illustrates another use of the exerciser in accordance with the present invention, wherein the user may stand on top of the semispherical member 21 for practicing balance.

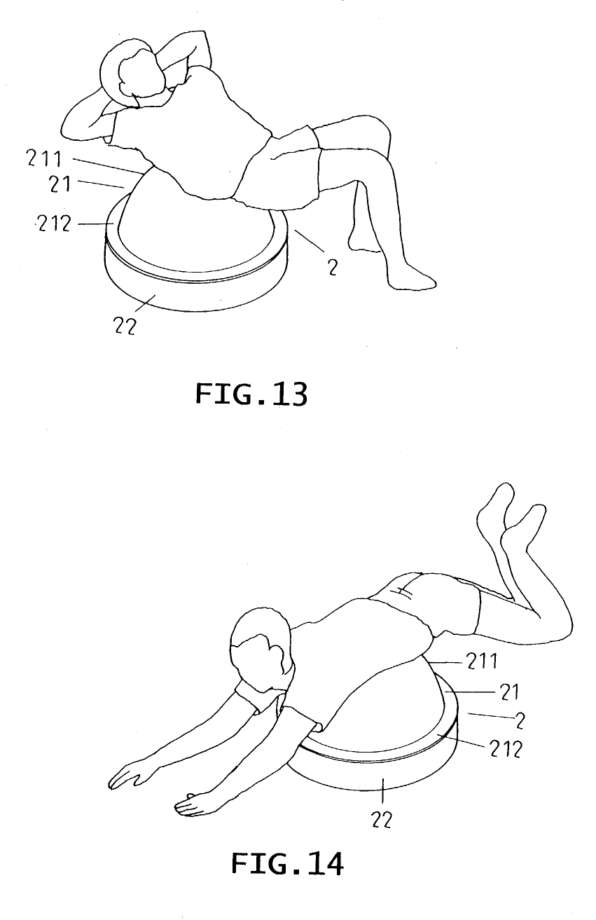

FIGS. 13 through 14 illustrate various uses of the exerciser in accordance with the present invention. Various parts of the user's body can be massaged by the protrusions 213 of the semispherical member 21. Thus, the exerciser in accordance with the present invention may also serve as a device for rehabilitation purposes.

Although the invention has been explained in relation to its preferred embodiments, it is to be understood that many other possible modifications and variations can be made without departing from the scope of the invention as hereinafter claimed.

What is claimed is:

1. An exerciser comprising:
a base including a top; and
a semispherical member including a semispherical periphery having a lower end, the lower end of the semispherical periphery of the semispherical member including an engaging portion for engaging with the top of the base, the semispherical member further including a bottom side that does not extend beyond a plane on which the lower end of the semispherical periphery of the semispherical member lies.

2. The exerciser as claimed in claim 1, wherein the bottom side of the semispherical member is arcuate and spaced apart from the top of the base.

3. The exerciser as claimed in claim 1, wherein the base includes a planar top face.

4. The exerciser as claimed in claim 1, wherein the engaging portion of the semispherical member includes an annular flange extending along the lower end of the semispherical periphery of the semispherical member, with a plurality of screws extending through the annular flange into the top of the base.

5. The exerciser as claimed in claim 4, wherein the annular flange extends in a plane perpendicular to a longitudinal direction of the exerciser.

6. The exerciser as claimed in claim 4, wherein the annular flange extends in a plane parallel to a longitudinal direction of the exerciser.

7. The exerciser as claimed in claim 1, wherein the top of the base includes a plurality of male engaging members and wherein the engaging portion of the semispherical member includes a plurality of female engaging members for engaging with the male engaging members.

8. The exerciser as claimed in claim 1, wherein the top of the base includes a plurality of female engaging members and wherein the engaging portion of the semispherical member includes a plurality of male engaging members for engaging with the female engaging members.

9. The exerciser as claimed in claim 1, wherein the engaging portion of the semispherical member includes an annular flange extending along the lower end of the semispherical periphery of the semispherical member, with a plurality of nails extending through the annular flange into the top of the base.

10. The exerciser as claimed in claim 1, wherein the engaging portion includes an annular flange extending along the lower end of the semispherical periphery of the semispherical member, with a plurality of straps for tying the annular flange and the top of the base together.

11. The exerciser as claimed in claim 1, wherein the semispherical periphery of the semispherical member includes a plurality of protrusions.

12. The exerciser as claimed in claim 1, wherein the base includes a plurality of base units.

13. The exerciser as claimed in claim 1, wherein the exerciser further includes a plurality of hooks, with a resilient pull string being attached to each said hook.

14. The exerciser as claimed in claim 1, wherein the engaging portion of the semispherical member includes a plurality of annularly spaced apart lugs projecting radially outward from the lower end of the semispherical periphery of the semispherical member.

15. The exerciser as claimed in claim 1, wherein the base includes an inverted bowl member extending downward from an inner side of the top of the base.
